(19) United States
(12) Patent Application Publication
(10) Pub. No.: US 2007/0101711 A1
(43) Pub. Date: May 10, 2007

(54) Servo-motor controlled hydraulic press, hydraulic actuator, and methods of positioning various devices

(75) Inventor: Jeffrey E. Debus, Ballwin, MO (US)

Correspondence Address: THOMPSON COBURN, LLP, ONE US BANK PLAZA, SUITE 3500, ST LOUIS, MO, 63101, US

(73) Assignee: The Beckwood Corporation

(21) Appl. No.: 11/267,801

(22) Filed: Nov. 4, 2005

(51) Int. Cl. F16D 31/02

(52) U.S. Cl. 60/476

(57) ABSTRACT

A hydraulic system that includes an actuator, a pump, a servo-motor, and (optionally) an actuator position sensor, an actuator hydraulic pressure sensor, a comparator, a servo-valve, and a hydraulic fluid filter. The pump communicates with the actuator and provides hydraulic fluid to the actuator to control it. Also, the pump includes a hydraulic fluid inlet, outlet, and a bypass path from the outlet to the inlet. The bypass path allows a portion of the hydraulic fluid to bypass the pump. In response to a signal to control the actuator, the servo-motor (which is operatively coupled to the pump) drives the pump. As a result of the bypass path, the servo-motor is able to run continuously thereby avoiding the on/off hysteresis of the pump. Methods of positioning hydraulic actuators are also provided.

### FIELD OF THE INVENTION

This invention relates generally to positioning and motion control systems and, more particularly, to hydraulic presses.

### BACKGROUND OF THE INVENTION

Previously, when precision hydraulic motion control was required (as is often the case when a hydraulic press is used to manufacture a product), manufacturers relied on proportional or servo hydraulic valves for precision control of hydraulic actuators. These expensive hydraulic components require special electrical control components and rely upon advanced hydraulic filtration systems for proper operation.

Yet, hydraulic presses have found many uses in low and moderate rate manufacturing processes. In addition, recent advances in pre-fill and regenerative hydraulic system design also allow high rate manufacturing using hydraulic presses. Hydraulic presses are preferred for many applications because their full tonnage can be developed at any point during the power stroke of the press. In contrast, mechanical presses can only develop maximum force at the bottom of the stroke. Furthermore, the developed force (and stroke speed) of a hydraulic press can be varied along the entire stroke without requiring additional floor space which is often at a premium in common manufacturing environments. Likewise, where overhead clearance is a concern, a hydraulic press can be used because the motor and pump of the hydraulic press can be positioned adjacent to, or even remote from, the press itself. Similarly, if the stroke length of a press needs to be changed hydraulic presses are frequently preferred because the necessary adjustments may be made to the actuator or programmed into the press. In contrast, the kinematic requirements of a mechanical press require a certain three dimensional envelope for the mechanical press.

Hydraulic presses, of course, can be designed to return upon the development of a desired pressure within the actuator of the press that corresponds to a desired force to be applied to a product via the actuator. For coining and embossing applications in particular, a press can be configured to generate a certain force on the part and then automatically return once this force has been achieved. This “pressure recognition” ability can also be used in punching and blanking applications where the punch travel depth in the die is critical. Punch tooling can be set up with adjustable fixed stops to protect the toolset, while allowing the ram to close to an exact and repeatable depth (due to the stops), build pressure on the stop blocks, and then automatically return. The features discussed above, as well as others, also make hydraulic presses better suited than mechanical presses for forming and drawing applications. These features also make hydraulic presses more adaptable for running a wide variety of dies in short-run and dedicated high-volume applications than mechanical presses.

Despite these advantages, hydraulic presses suffer from a relative inability to precisely position the press (or to move the actuator in accordance with a pre-determined motion profile). Hydraulic servo-valves or proportional valves are therefore sometimes added to hydraulic presses to provide improved positioning and motion control. Unfortunately, hydraulic servo-valves or proportional valves fail frequently because of particulate contamination that can be carried into the tight clearances between the moving components of the servo-valve (particularly the annular space between the spool and the body of the valve). Even if the hydraulic fluid is filtered, transient particulate contamination can still cause intermittent failures of these servo-valves. Moreover, these servo-valves can be quite expensive and necessarily introduce added complexity into the systems in which they are placed. Thus, a need exists to improve the positioning and motion control capabilities of hydraulic presses without the need for servo or proportional valves.

### SUMMARY OF THE INVENTION

It is in view of the above problems that the present invention was developed. The invention provides hydraulic positioning and motion control systems and methods of positioning and moving devices. More particularly, the present invention provides a system to position a hydraulic actuator with the precision that heretofore was only associated with the use of servo or proportional valves. Furthermore, the benefits provided by the present invention can be provided even without the use of these servo-valves. Moreover, precise closed loop control of the actuator's position can be achieved in accordance with the principles of the present invention.

Because that portion of the hydraulics industry that uses servo-valves is very small and specialized, economies of scale can not currently be realized in this portion of the hydraulics industry. On the other hand, servo-motors and variable frequency drives (VFDs) are employed in a large variety of industries and therefore enjoy the economies of scale that come with such wide spread use. By using servo-motors in combination with hydraulic actuators, the positioning and motion control systems provided by the present invention enjoy the economies of scale that have not been available for these applications. As used herein a servo-motor includes any motor that responds to a control signal by changing its speed or other operating parameters. Thus, the combination of a VFD driven motor is one example of a servo-motor.

Thus, in a first preferred embodiment, the present invention provides a hydraulic system that includes an actuator, a pump, a servo-motor, and (optionally) an actuator position sensor, an actuator hydraulic pressure sensor, a comparator, a servo-valve, and a hydraulic fluid filter. The pump communicates with the actuator and provides hydraulic fluid to the actuator to move or pressurize it (i.e., to control the actuator). Also, the pump includes a hydraulic fluid inlet, a hydraulic fluid outlet, and a bypass path between the outlet and the inlet. The bypass path allows a portion of the hydraulic fluid to flow back around the pump with little opposition (i.e., bypass the pump). In response to a signal to control the actuator, the servo-motor (which is operatively coupled to the pump) drives the pump to supply hydraulic fluid to the actuator. As a result of the bypass path, the servo-motor is able to run substantially continuously.

Preferably, the pump is a reversible (or bi-directional) gear pump with an internal leak path that serves as the bypass path. Because the bypass path allows the motor to run substantially continuously, the bypass path causes the system to avoid the occurrence of the on/off hysteresis that is associated with the motor. In embodiments that include the position sensor and the comparator, the comparator generates the control signal by comparing the sensed actuator position with a desired position signal which can be time carrying. For those embodiments including the pressure sensor, the comparator can also generate the control signal based on a comparison of the sensed pressure and a desired actuator pressure. Since, in part, the servo-motor driven pump is insensitive to particulate contamination the system need not include a hydraulic fluid filter although it could include such a filter.

In a second preferred embodiment, the present invention provides a hydraulic press that includes a hydraulic system. The press, of course, can perform blanking motions, coining motions, forging motions, embossing motions, knuckle press motions, and draw motions with (or without) dwell at the bottom of the draw motion. Preferably, the operator can select the type of motion profile via an operator interface, network, or programmable logic controller.

In a third preferred form, the invention provides a method that includes driving a pump with a servo-motor in response to a signal to control a hydraulic actuator (where the servo-motor is operatively coupled to a pump and the pump is, in turn, in communication with the actuator). Additionally, the method includes using the pump to provide hydraulic fluid to the actuator to control the actuator. The method also includes bypassing a portion of the hydraulic fluid around the pump (preferably via a leak path that is internal to the pump) whereby the servo-motor runs substantially continuously. Preferably, the method also includes reversing the direction of the pump while avoiding the on/off hysteresis associated with the motor. Of course, controlling the actuator may be via comparing the sensed position of the actuator (or a sensed pressure in the actuator) with a desired position (or pressure) signal. Additionally, the method may include varying the desired position and/or pressure signal so that the actuator performs either a blanking motion, a coining motion, a forging motion, an embossing motion, a knuckle press motion, a draw motion, or a draw motion with or without a dwell at the bottom of the motion. Further, the operator can select the type of motion profile to be performed

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate exemplary embodiments of the present invention and together with the description, serve to explain the principles of the invention. In the drawings:

FIG. 1 illustrates a hydraulic system that is constructed in accordance with the principles of the present invention;

FIG. 2 illustrates a schematic of a hydraulic system of another preferred embodiment of the present invention;

FIG. 3 illustrates a perspective view of a hydraulic press of a preferred embodiment of the present invention;

FIG. 4 illustrates a perspective view of a servo-motor driven hydraulic pump of the hydraulic press shown in FIG. 3;

FIG. 5 illustrates several press cycles of the hydraulic press of FIG. 3; and

FIG. 6 illustrates a method performed in accordance with the principles of the present invention.

### DETAILED DESCRIPTION OF THE PREFERRED EMBODIMENTS

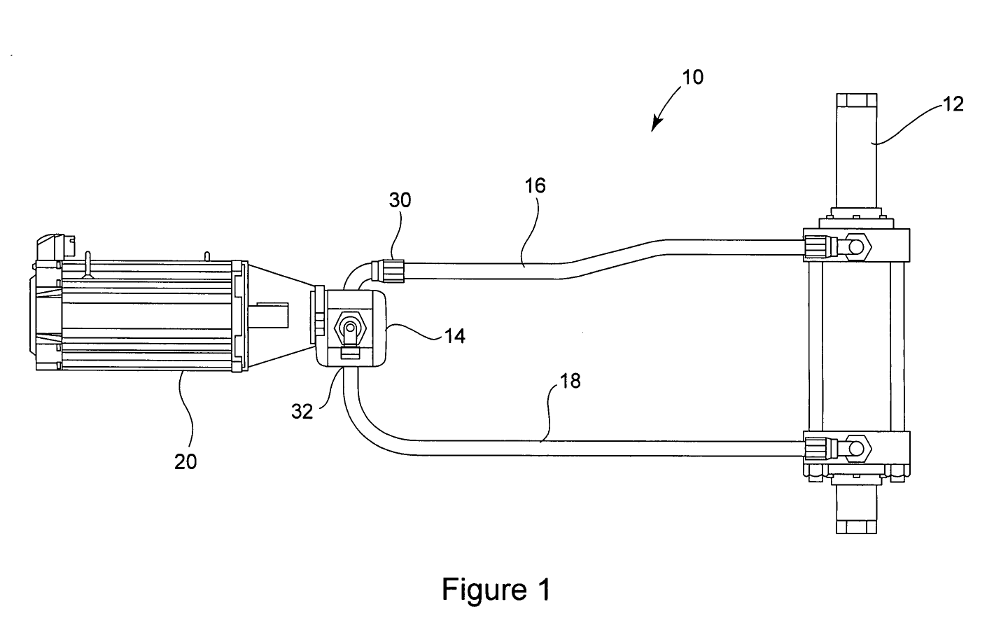

Referring to the accompanying drawings in which like reference numbers indicate like elements, FIG. 1 illustrates a hydraulic system that is constructed in accordance with the principles of the present invention. While the system 10 of the embodiment shown in FIG. 1 can be used in a hydraulic press, the system 10 could be used in any application where it is desired to position an actuator according to some predetermined path or in response to disturbances that change the desired position of, or force output by, the actuator. The system 10 includes an actuator 12, a pump 14, a pair of fluid lines 16 and 18 that interconnect the actuator 12 and the pump 14, and a servo-motor 20. The pump 14 shown is preferably a bi-directional gear pump while the servo-motor 20 is preferably any electric motor capable of driving the pump 14 and that is driven by a variable frequency drive or other servo-mechanism. In the preferred embodiment of FIG. 1 no servo-valve is included to position the actuator 12 although a servo-valve, a proportional valve, or basic directional control valve could be added to the system 10. Rather, the pump 14 and the motor 20 are used to control the actuator 12.

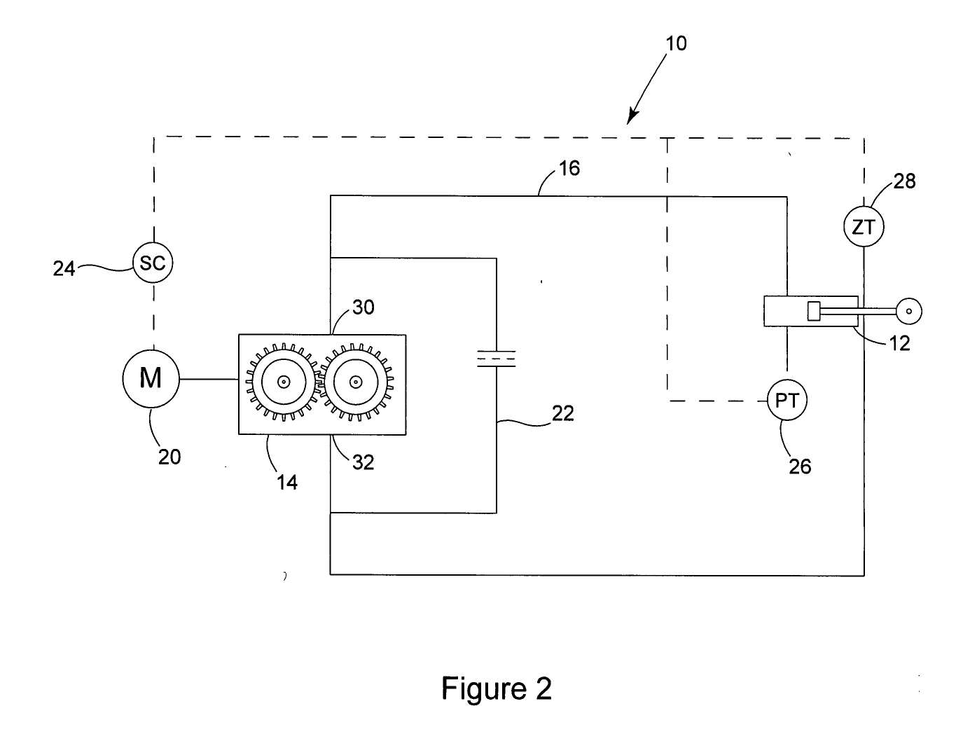

FIG. 2 schematically shows additional components of the system 10. More particularly, FIG. 2 shows a bypass path 22, a speed controller (e.g., a variable frequency drive) 24, a pressure sensor 26, and a position sensor 28. The sensors 26 and 28 respectively sense the pressure in the actuator 12 and the position of the actuator 12. Signals that represent these parameters are communicated to the controller 24 which compares the sensed parameter to a desired value and adjusts the speed of the pump 14 (via the motor 20) accordingly. In this manner, the sensed parameter causes the flow rate and/or pressure of the hydraulic fluid flowing to the actuator 12 to change in such a manner that the actuator 12 moves to the desired position or the pressure within the actuator 12 changes to reach the desired pressure. In other words, the motor 20 is used to control the actuator 12 without the need for a servo-valve (as used herein references to servo-valves will be understood to include proportional valves and directional control valves).

Of note, the bypass path 22 plays a role in this control scheme. It is well known that motors 20 have an associated on/off hysteresis. This hysteresis has previously prohibited motors 20 from being used to control actuators 12 directly (i.e., without a servo-valve). This result occurs because the on/off hysteresis of the motor causes a dead band in the control loop of conventional systems that prohibits precise control of the actuator 12. Of course, the on/off hysteresis also introduces a lag in these conventional control loops that further complicates controlling the actuator 12. However, according to the principles of the present invention, the bypass path 22 allows the system 10 to operate despite the existence of the motor's hysteresis because the bypass path 22 allows the pump 14 to run continuously. In fact, the pump 14 can run continuously even if the control loop commands no change in the hydraulic fluid flow rate to control the actuator 12. That portion of the hydraulic fluid that is in excess of the fluid flow need to control the actuator 12 simply bypasses the actuator 12 via the bypass path 22. Of course, the bypass path 22 is sized to provide some resistance to fluid flow such that a sufficient portion of the fluid flows to the actuator 12 to control the actuator 12. For that reason, in part, FIG. 2 shows the bypass path as including an orifice 34. Meanwhile, the speed controller 24 compensates for any variations that might arise thereby providing precise, closed loop control of the actuator 12. As the pump 14 experiences wear and loss of efficiency through operation the bypass leakage and hysteresis tends to increase. However, in accordance with the principles of the present invention, the ability to run the motor 20 continuously adequately compensates for these and other changes in the pump's performance. Thus, in contrast with previous attempts to control the position or motion of the actuator 12, wear does not negatively affect the performance of the system 10.

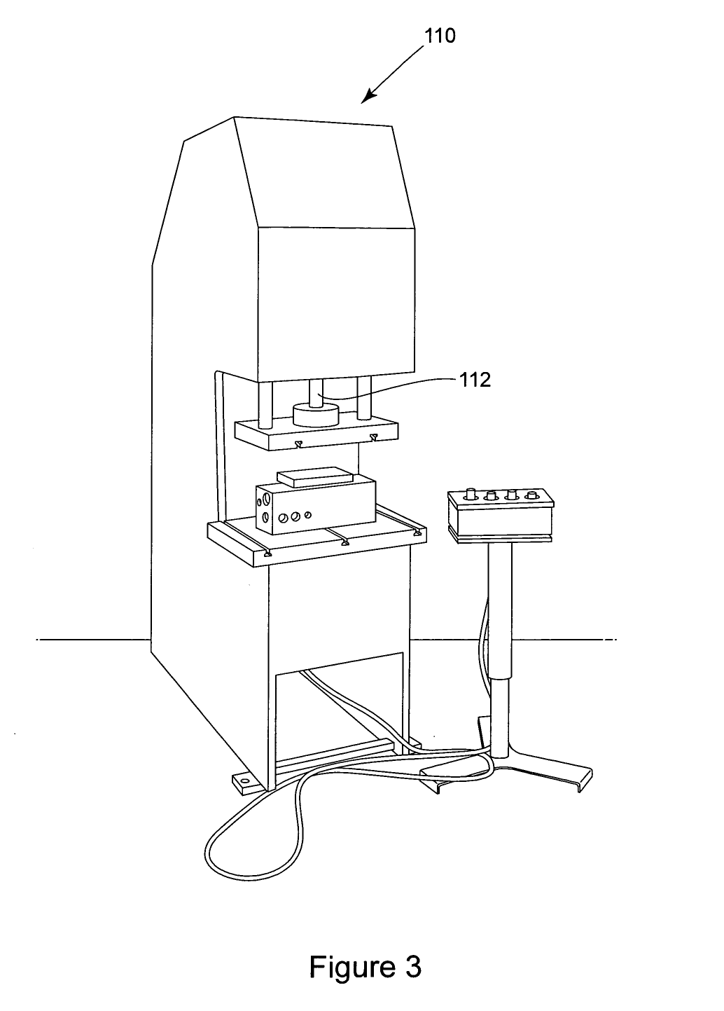

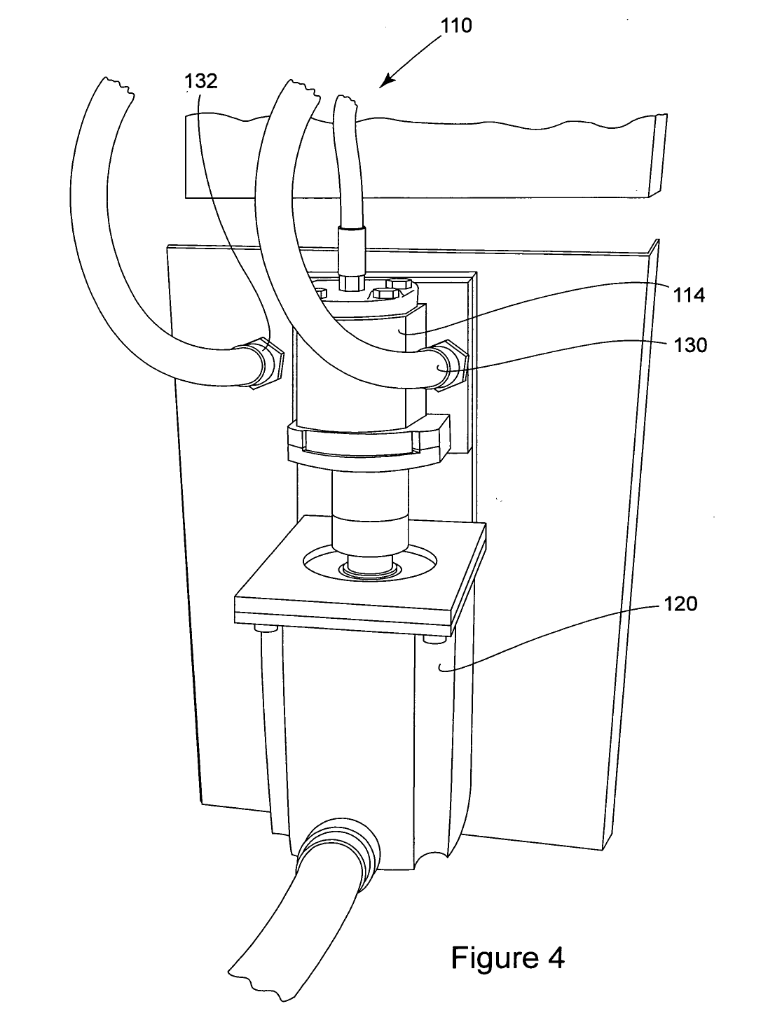

With reference now to FIGS. 3 and 4, a hydraulic press 110 is shown which is constructed in accordance with the principles of the present invention. The system 110 is flexible and preferably includes a low-end, fixed displacement, bi-directional gear pump 114 with nominal 95% efficiency and a moderate amount of internal leakage. Of course, while such internal leakage is generally regarded as a source of inefficiency, the present invention uses the internal leakage to the advantage of the system's operator (i.e., the internal leakage allows the pump to run continuously and thereby avoid hysteresis). In a preferred embodiment, the pump 114 is a Model No. ALP2AR40-E2 gear pump that is available from Marzocchi Pump SPA of Bologna, Italy. One of the advantages of using the Model No. ALP2AR40-E2 gear pump is that the internal clearances in the pump 114 are of about the correct size to provide the bypass path without the need for an external line. Thus, with this particular type of pump, the internal leak path of the pump 114 serves as the pump bypass path. In general, there is no required range of bypass flow that is needed for the practice of the present invention. In fact, tests indicate that any similar pump will work with differences in performance between pumps being compensated for by the VFD (or servo-motor). Regarding the other major mechanical component of the system, the actuator 112 can be a Model No. 5KK2HLTS155/14AX8.00 hydraulic actuator that is available from Parker Hannifin of Cleveland, Ohio.

Regarding the feedback portion of the system shown schematically in FIG. 2, a preferred controller 24 includes an Allen-Bradley Ultra™3000 model drive available from Rockwell Automation of Milwaukee, Wis. that cooperates with an Allen-Bradley Logix programmable logic controller (PLC) to receive the pressure and position signals, compare them to the desired pressure and/or position, and control the speed of the motor 120 accordingly. For convenience, the VFD and PLC have been shown schematically as one controller 24 in FIG. 2 although they are separately installed in the cabinet that houses the press 110 shown in FIGS. 3 and 4. In another preferred embodiment; the controller 24 includes an RMC-4000 Motion Control System that is available from Delta Computer Systems, Inc. of Vancouver, Wash. Regarding the motor 120, a Model No. HC-SFS702K motor that is available from Allen Bradley (Rockwell Automation) can be used.

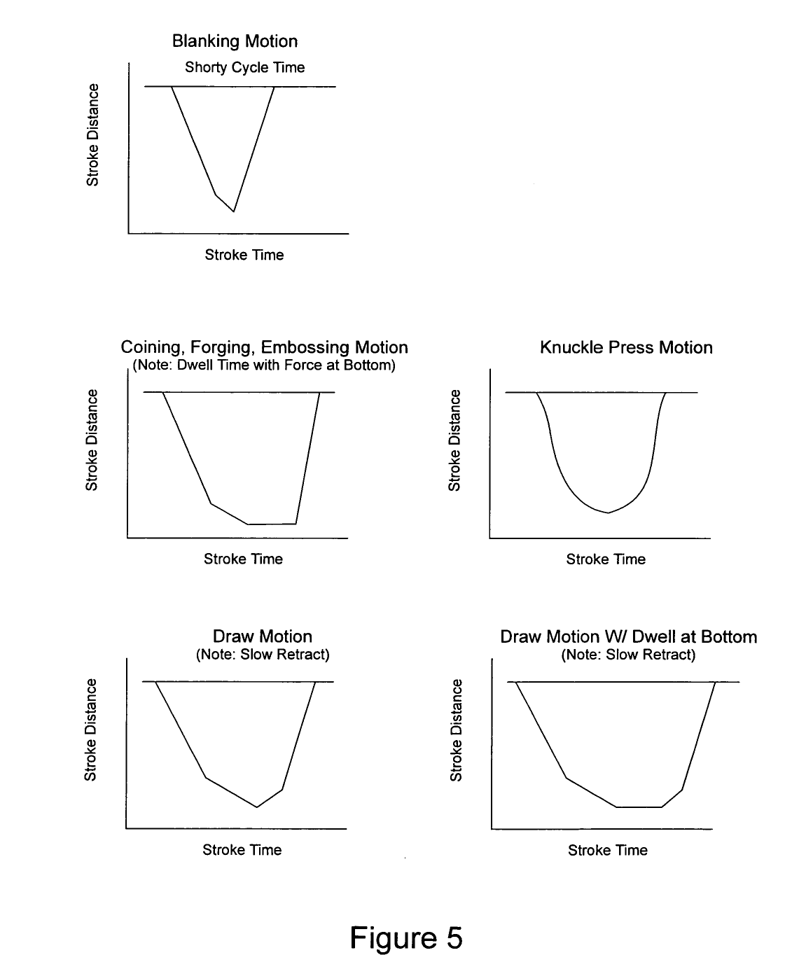

It has been demonstrated that the servo-motor (the combination of the motor 120 and the VFD) of the press 110 of FIGS. 3 and 4 can control the motion of the actuator 112 to produce products of superior quality. More particularly, the press 110 can be controlled to provide the exemplary actuator motion profiles shown in FIG. 5. For instance, the press 110 can execute a blanking motion in which the actuator 112 is driven first in one direction, then slowed toward the end of the initial stroke, and returned to its starting position. A coining, forging, or embossing motion has also been successfully executed as indicated by FIG. 5. These motions are similar to the blanking motion with the addition of a dwell period being added at the end of the initial stroke to continue applying force to the blank or product. Similarly, a draw motion was executed in which the actuator was slowed toward the end of the initial stroke and sped up shortly after the beginning of the return stroke (with or without a dwell period at the end of the initial stroke). Moreover, the hydraulic press 110 of FIGS. 3 and 4 can be used to produce more complex motion profiles than the linearly ramped profiles so far discussed. For instance, the knuckle press profile shown in FIG. 5 indicates the successful demonstration of more complex curvilinear motion profiles. Of course, the exemplary motion profiles shown in FIG. 5 can be programmed into the controller 124.

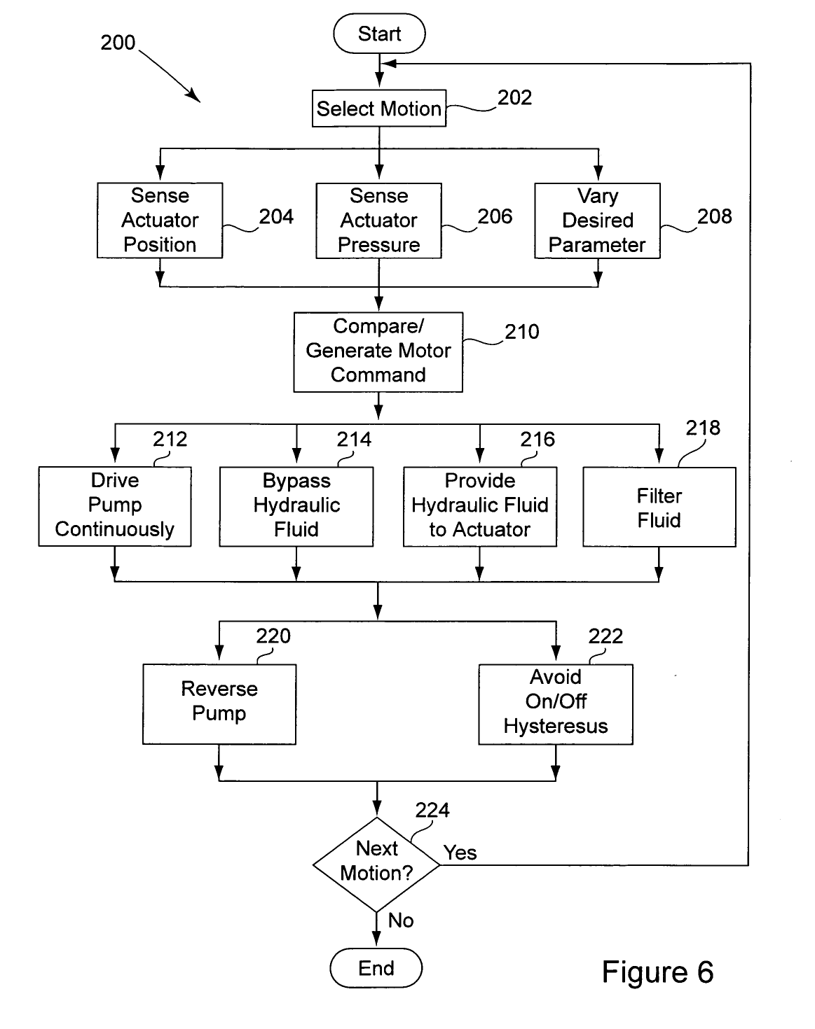

With reference now to FIG. 6, the present invention also provides methods of position and motion control. The method 200 includes selecting a motion profile in operation 202. AS shown in operations 204 and 206, respectively, the method 200 may also include sensing either the position of a hydraulic actuator or the pressure with in the actuator. Of course, the method may include comparing the parameter(s) sensed in operations 204 and 206 with a desired value for the parameters. Since the desired values of these parameters may vary with time, the method 200 can include varying these desired values as indicated at operation 208. Whether the desired parameters vary, the comparison of the sensed parameters and the desired values is shown as operation 210.

In response to the comparison of operation 210, a hydraulic fluid pump is driven in operation 212. Because a portion of the hydraulic fluid pumped by the pump is allowed to return to the pump's inlet, the pump is allowed to run continuously. See operation 214. The remainder of the hydraulic fluid flows to the actuator and either causes the actuator to move or pressurizes it as shown in operation 216. Since the control of the actuator shown in operation 216 may be accomplished without a servo-valve, the hydraulic fluid need not be filtered. However, if desired, operation 218 shows that the hydraulic fluid may be filtered.

Depending, on the comparison between the sensed and desired actuator parameters (see operations 204, 206, 208, and 210), it may be desirable to reverse the direction of the pump and the fluid flow rate through the pump and actuator. Such a flow reversal is illustrated by operation 220. In a conventional system, of course, such a reversal (or even a temporary stopping of the motor without a reversal) would cause the occurrence of the on/off hysteresis of the motor. However, because bypassing the fluid allows the pump to operate continuously (see operations 212 and 214) the hysteresis is avoided and the desired position or motion control can be provided with a high degree of precision. The avoidance of the hysteresis is shown at operation 222. As indicated by operation 224, another motion or cycle can be selected and executed in accordance with the method 200.

In view of the foregoing, it will be seen that the several advantages of the invention are achieved and attained. More particularly, hydraulic systems have been provided that deliver repeatable and precise position and motion control. Also, hydraulic presses have been provided that can repeatedly and precisely control the amount of force generated throughout the cycle of these presses. For instance, in molding or deep drawing applications, the clamping forces developed by these exemplary presses can be altered throughout the cycle to aid in material flow or material curing.

One of the benefits provided by closed loop control embodiments of the present invention (e.g. positioning systems with position or pressure feedback control loops) is that multiple and independently controlled positioning systems can fiction in parallel to one another. Thus, one system can serve as a boss, or primary system, while the other systems serve as slaves or secondary systems that function to mimic the performance of the primary.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. For example, the ability of the exemplary hydraulic presses described herein to control the developed force is not limited to only vertical force. Further, by using multiple cylinder configurations, the press can deliver different forces to different areas of the tooling associated with any given job. Moreover, moving the hydraulic actuators of the presses to off-center positions in the press crown facilitates distributing the applied force to off-centered multiple die sets where such arrangements may be desirable. Thus, sophisticated manufacturing applications can be accomplished by providing forces where they are required in accordance with the principles of the present invention. Thus, the breadth and scope of the present invention should not be limited by any of the exemplary embodiments, but should be defined in accordance with the claims and their equivalents.

What is claimed is:

1. A hydraulic system comprising:
an actuator;
a pump in fluid communication with the actuator to provide hydraulic fluid to the actuator to control the actuator, the pump having a hydraulic fluid inlet, a hydraulic fluid outlet, and a bypass path from the hydraulic fluid outlet to the hydraulic fluid inlet, the bypass path being sized to allow a portion of the hydraulic fluid to bypass the pump; and
a servo-motor operatively coupled to the pump to drive the pump in response to a signal to control the actuator, whereby the bypass path allows the servo-motor to run substantially continuously.

2. The system of claim 1 further comprising the pump being a reversible gear pump.

3. The system of claim 2 further comprising the bypass path being an internal leak path of the gear pump.

4. The system of claim 1 wherein the servo-motor includes a variable frequency drive.

5. The system of claim 1 wherein the servo-motor has an on/off hysteresis associated with it, whereby the bypass path allows the servo-motor to run substantially continuously thereby avoiding the occurrence of the on/off hysteresis.

6. The system of claim 1 further comprising a sensor to sense a position of the actuator.

7. The system of claim 6 further comprising a comparator to compare the sensed actuator position to a desired position signal thereby generating the control signal.

8. The system of claim 7 wherein the desired position signal is time varying.

9. The system of claim 6 further comprising a pressure sensor in fluid communication with the actuator to sense the hydraulic pressure in the actuator and in electronic communication with the comparator, the comparator to compare the sensed hydraulic pressure with a desired hydraulic pressure, the comparator thereby generating the control signal.

10. The system of claim 1 wherein the hydraulic fluid contains particulate contamination of a size and a concentration sufficient to cause a servo-valve to malfunction.

11. The system of claim 1 further comprising being a hydraulic press.

12. A hydraulic press comprising:
an actuator;
a gear pump in fluid communication with the actuator to provide substantially unfiltered hydraulic fluid to the actuator to control the actuator, the gear pump having a hydraulic fluid inlet, a hydraulic fluid outlet, and an internal leak path from the hydraulic fluid outlet to the hydraulic fluid inlet, the leak path being of a size to allow a portion of the hydraulic fluid provided to bypass the gear pump;
a variable frequency drive operatively coupled to the gear pump to drive the pump in response to a signal to control the actuator, the variable frequency drive having an on/off hysteresis associated with it, whereby the leak path allows the variable frequency drive to run substantially continuously thereby avoiding the on/off hysteresis;
a sensor to sense a position of the actuator; and
a comparator to compare the sensed actuator position to a desired position signal thereby generating the control signal, the desired position signal being selected in such a manner that the desired position signal causes the hydraulic press to perform at least one of a blanking motion, a coining motion, a forging motion, an embossing motion, a knuckle press motion, a draw motion, or a draw motion with dwell at a bottom of the draw motion, the type of motion being selectable by an operator of the hydraulic press.

13. The press of claim 12 further comprising a pressure sensor in fluid communication with the actuator to sense the hydraulic pressure in the actuator and in electronic communication with the comparator, the comparator to compare the sensed hydraulic pressure with a desired hydraulic pressure, the comparator thereby further generating the control signal.

14. A method comprising:
driving a pump with a servo-motor in response to a signal to control an actuator, the servo-motor being operatively coupled to a pump, the pump being in communication with the actuator;
using the pump to provide hydraulic fluid to the actuator to control the actuator; and
bypassing a portion of the hydraulic fluid around the pump whereby the bypassing a portion of the hydraulic fluid allows the servo-motor to run substantially continuously.

15. The method of claim 14 further comprising reversing the direction of the pump.

16. The method of claim 14 further comprising the bypassing of the hydraulic fluid being internal to the pump.

17. The method of claim 14 further comprising avoiding the occurrence of an on/off hysteresis that is associated with the servo-motor.

18. The method of claim 14 further comprising sensing a position of the actuator.

19. The method of claim 18 further comprising comparing the sensed actuator position to a desired position thereby generating the control signal.

20. The method of claim 19 further comprising varying the desired position signal.

21. The method of claim 14 further comprising sensing the hydraulic pressure in the actuator, comparing the sensed hydraulic pressure with a desired hydraulic pressure thereby generating the control signal based on the comparison of the sensed hydraulic pressure and the desired hydraulic pressure.

22. The method of claim 14 further comprising filtering the hydraulic fluid.

23. The method of claim 14 further comprising using the actuator to perform at least one of a blanking motion, a coining motion, a forging motion, an embossing motion, a knuckle press motion, a draw motion, or a draw motion with dwell at a bottom of the draw motion.

24. The method of claim 23 further comprising selecting the type of motion.
